(19) United States
(12) Patent Application Publication
(10) Pub. No.: US 2025/0383769 A1
(43) Pub. Date: Dec. 18, 2025

(54) MANAGING MAPPINGS DURING ZONIFICATION

(71) Applicant: Micron Technology, Inc., Boise, ID (US)

(72) Inventors: Cun Chen, Shanghai (CN); Xiao Wang, Shanghai (CN)

(21) Appl. No.: 19/221,050

(22) Filed: May 28, 2025

Related U.S. Application Data
(60) Provisional application No. 63/659,452, filed on Jun. 13, 2024.

(51) Int. Cl. G06F 3/06; G06F 12/1009

(52) U.S. Cl. CPC G06F 3/0608; G06F 3/064; G06F 3/0673; G06F 12/1009

(57) ABSTRACT

Methods, systems, and devices for managing mappings during zonification are described. A memory system may implement a zoned architecture, where virtual blocks of the memory system are separated into respective zones. The memory system may transfer data from a first zone to a second zone of the memory system. In response, the memory system may modify a mapping table to include information associated with an entry of a change log generated by transferring the data from the first zone to the second zone. The memory system may perform a read scan procedure to identify whether a program failure has occurred as part of transferring the data from the first zone to the second zone. If a program failure is identified, the memory system may perform an error handling procedure to recover the data from the first zone using the mapping table.

### CROSS REFERENCE

The present Application for Patent claims priority to U.S. Patent Application No. 63/659,452 by Chen et al., entitled “MANAGING MAPPINGS DURING ZONIFICATION,” filed Jun. 13, 2024, which is assigned to the assignee hereof, and which is expressly incorporated by reference in its entirety herein.

### TECHNICAL FIELD

The following relates to one or more systems for memory, including managing mappings during zonification.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports managing mappings during zonification in accordance with examples as disclosed herein.

FIG. 2 shows an example of a zoned architecture that supports managing mappings during zonification in accordance with examples as disclosed herein.

FIG. 3 shows an example of a process flow that supports managing mappings during zonification in accordance with examples as disclosed herein.

FIG. 4 shows an example of a mapping table that supports managing mappings during zonification in accordance with examples as disclosed herein.

FIG. 5 shows a block diagram of a memory system that supports managing mappings during zonification in accordance with examples as disclosed herein.

FIG. 6 shows a flowchart illustrating a method or methods that support managing mappings during zonification in accordance with examples as disclosed herein.

### DETAILED DESCRIPTION

Some memory systems may implement a zoned architecture in which physical blocks of memory cells (e.g., address spaces of the memory system) may be divided into one or more zones. Each zone of the memory system may correspond to one or more virtual blocks, where each of the one or more virtual blocks may be associated with the one or more physical blocks of memory cells. In some examples, the memory system may perform a zonification procedure to move the data from a source zone (e.g., a first zone, a temporary zone, or an un-zoned portion of memory) to a destination zone of the memory system. For example, during the zonification procedure, the memory system may write the data from the source zone to the destination zone sequentially using a write cursor (e.g., an address pointer). In response to writing the data to the destination zone, the memory system may perform one or more verification procedures (e.g., read scan procedures or redundant array of independent NAND (RAIN) procedures) to determine whether the data was correctly written to the destination zone (e.g., identify program failures in the zonification procedure).

For example, during a read scan procedure, the memory system may lock one or more virtual blocks associated with the data in the source zone, such that if program failures are identified, the memory system may recover the data from the one or more virtual blocks in the source zone and rewrite the data to the destination zone. During a RAIN procedure, the memory system may generate and write one or more parity bits associated with the data to one or more retention buffers in addition to writing the data to the destination zone. In this way, if the memory system identifies program failures, the memory system may recover the data using the parity bits stored in the one or more retention buffers and rewrite the data to the destination zone. In such examples, however, during the one or more verification procedures, the memory system may experience a reduction in resources. The reduction in resources may be due to locking of various zones until the verification procedures are complete. Such a reduction in resources may be further increased as the size of the data written to the destination increases (e.g., quantity of locked source virtual blocks increases, size of the one or more retention buffers increase, among other examples). Thus, techniques to eliminate the reduction of resources during the one or more verification procedures may be desirable.

The techniques, methods, and devices described herein may enable the memory system to refrain from locking the one or more virtual blocks of the source zone during the zonification procedure, reduce the size, or eliminate the use, of the one or more retention buffers, or both during the one or more verification procedures. For example, because the data is written sequentially to the destination zone during the zonification procedure, the memory system may maintain a compressed version of a change log (e.g., a logical to physical (L2P) change log) in a mapping table during the zonification procedure. Accordingly, if the memory system identifies a program fail, the memory system may perform an error handling procedure to recover the data using the mapping table. For example, the memory system may identify a physical page address (PPA) of the data at the source zone using the entries of the mapping table (e.g., using the compressed L2P entries of the mapping table). Based on identifying the PPA of the data in the source zone, the memory system may perform a synchronization read operation to recover the data from the source zone and rewrite the data to the destination zone. In this way, the memory system may avoid locking the one or more virtual blocks associated with the data in the source zone and reduce the size, or eliminate the use, of the one or more retention buffers.

In addition to applicability in memory systems as described herein, techniques for managing mappings during zonification may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by eliminating the reduction of resources during zonification procedures, which may decrease processing or latency times, improve response times, or otherwise improve user experience, among other benefits.

Features of the disclosure are illustrated and described in the context of systems, devices, and circuits. Features of the disclosure are further illustrated and described in the context of zoned architectures, process flows, mapping tables, and flowcharts.

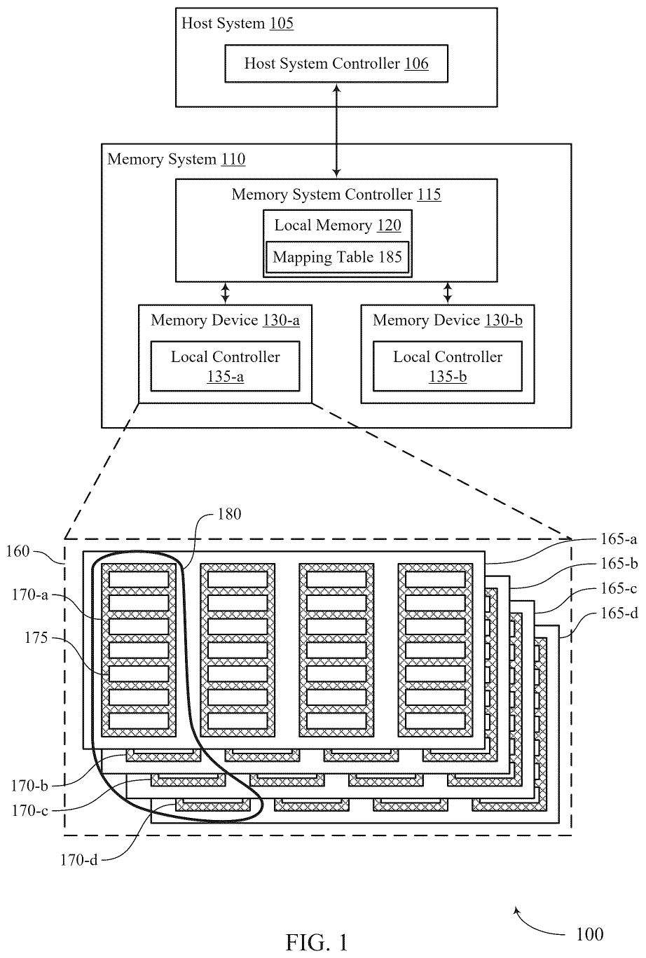

FIG. 1 shows an example of a system 100 that supports managing mappings during zonification in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the memory system 110 may implement a zoned architecture in which the blocks 170 may be divided into one or more zones. For example, each zone of the memory system 110 may correspond to one or more virtual blocks 180, where each of the one or more virtual blocks 180 may be associated with the one or more blocks 170. In some examples, the memory system 110 may perform a zonification procedure to move the data from a source zone (e.g., a first zone, a temporary zone, or an un-zoned portion of memory) to a destination zone of the memory system 110. For example, during the zonification procedure, the memory system 110 may write the data from the source zone to the destination zone sequentially using a write cursor (e.g., an address pointer). In response to writing the data to the destination zone, the memory system 110 may perform one or more verification procedures (e.g., read scan procedures or RAIN procedures) to determine whether the data was correctly written to the blocks 170 of the destination zone (e.g., identify program failures in the zonification procedure).

For example, during a read scan procedure, the memory system 110 may lock one or more virtual blocks 180 associated with the data in the source zone, such that if program failures are identified, the memory system 110 may recover the data from the one or more virtual blocks 180 in the source zone and rewrite the data to the destination zone. During a RAIN procedure, the memory system 110 may write the data to one or more retention buffers (e.g., stored in the local memory 120) in addition to writing the data to the destination zone. In this way, if the memory system 110 identifies program failures, the memory system 110 may recover the data from the one or more retention buffers and rewrite the data to the destination zone. In such examples, however, during the one or more verification procedures, the memory system 110 may experience a reduction in resources, where such a reduction in resources may be further increased as the size of the data written to the destination increases (e.g., quantity of locked source virtual blocks 180 increases, size of the one or more retention buffers increase, among other examples). Thus, techniques to eliminate the reduction of resources during the one or more verification procedures may be desirable.

The techniques, methods, and devices described herein may enable the memory system 110 to refrain from locking the one or more virtual blocks 180 of the source zone during the zonification procedure, reduce the size, or eliminate the use, of the one or more retention buffers, or both during the one or more verification procedures. For example, because the data is written sequentially to the destination zone during the zonification procedure, the memory system 110 may maintain a compressed version of a change log (e.g., a L2P change log) in a mapping table 185 during the zonification procedure. In some examples, the memory system controller 115 may maintain the mapping table 185, where the mapping table 185 may be used to store the compressed version of the change logs for each of the memory devices 130. Alternatively, the memory system controller 115 may maintain a respective mapping table 185 for each memory device 130 of the memory system 110. In some other examples, each memory device, via the local controllers 135, may maintain a respective mapping table 185.

Accordingly, if the memory system 110 identifies a program fail, the memory system 110 may perform an error handling procedure to recover the data using the mapping table 185. For example, the memory system 110 may identify a PPA of the data at the source zone using the entries of the mapping table 185 (e.g., using the compressed L2P entries of the mapping table 185). Based on identifying the PPA of the data in the source zone, the memory system 110 may perform a synchronization read operation to recover the data from the source zone and rewrite the data to the destination zone. In this way, the memory system 110 may avoid locking the one or more virtual blocks 180 associated with the data in the source zone and reduce the size, or eliminate the use, of the one or more retention buffers.

The system 100 may include any quantity of non-transitory computer readable media that support managing mappings during zonification. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

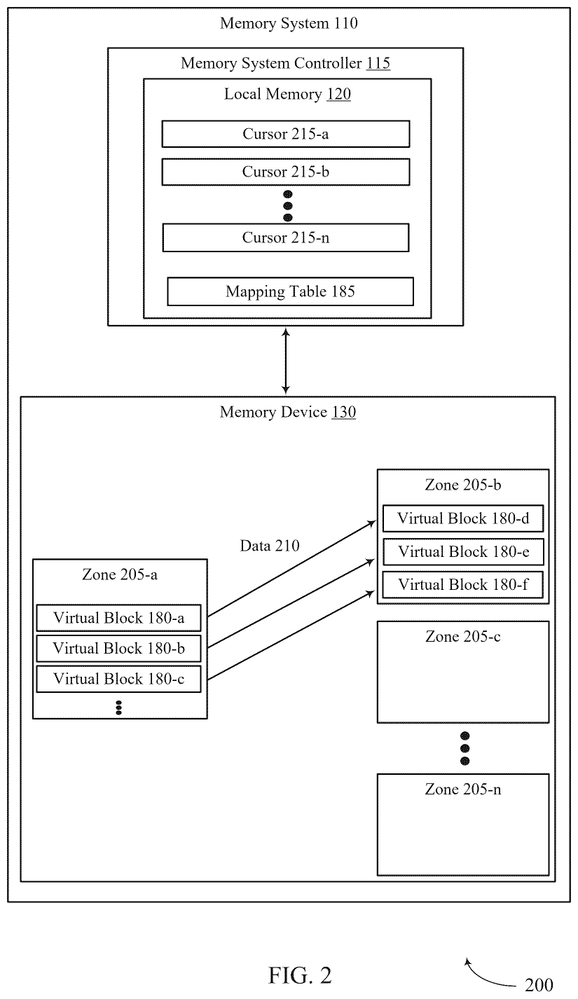

FIG. 2 shows an example of a zoned architecture 200 that supports managing mappings during zonification in accordance with examples as disclosed herein. Aspects of the zoned architecture 200 may implement, or be implemented by, aspects of the system 100 as described herein with reference to FIG. 1. For example, the zoned architecture 200 may be implemented by one or more memory devices 130 of the memory system 110. The techniques described in the context of the zoned architecture 200 may enable the memory system 110, via the memory system controller 115, to maintain a mapping table 185 that includes one or more compressed entries of a change log (e.g., L2P change log) that is generated in response to (e.g., based on) transferring data 210 from a zone 205-a (e.g., a first zone) to a zone 205-b (e.g., a second zone).

For example, the memory device 130 may include the zone 205-a, where the zone 205-a may be an example of a temporary zone (e.g., or unzoned memory) used by the memory device 130 to store data 210 prior to writing the data to one of the zones 205. Alternatively, the zone 205-a may be a dedicated zone of the memory device 130. Additionally, the memory device 130 may include the zone 205-b, a zone 205-c, through a zone 205-n, which may be dedicated zones of the memory device 130. As described herein, in the zoned architecture 200, each zone 205 may be associated with one or more virtual blocks 180. For example, the zone 205-a (e.g., first zone, temporary zone, or unzoned memory) may be associated with a first set of virtual blocks 180, such as the virtual block 180-a, the virtual block 180-b, and the virtual block 180-c, while the zone 205-b may be associated with a second set of virtual blocks 180, such as the virtual block 180-d, the virtual block 180-c, and the virtual block 180-f. Likewise, the zone 205-c may be associated with a second set of virtual blocks 180, while the zone 205-n may be associated with an n^{th} set of virtual blocks 180.

In order for the memory system 110 to acquire various performance benefits, such as increased access speeds, reduced latency during access operations, or the like, the memory device 130 may perform zonification procedures (e.g., zonification collation, zone writes, zone copies, among other examples). The zonification procedures may involve the memory system 110 writing data 210 from the virtual blocks 180 of the zone 205-a to the virtual blocks 180 of the zone 205-b (e.g., from a temporary zone to a dedicated zone, from an unzoned portion of memory to a dedicated zone, or between zones). In such examples, the memory system 110 may write the data 210 to the zone 205-b in a sequential manner. For example, the memory system 110 may write the data 210 to the physical blocks associated with the virtual blocks 180 of the zone 205-b in a sequential order.

To support such sequential zonification procedures, the memory system 110 may implement a quantity of cursors 215 (e.g., write pointers), where each cursor 215 may point to the physical block (e.g., physical address) of the zone 205 at which the data 210 is to be written. As such, in response to the data 210 being written to the physical blocks pointed to by the cursor 215-a, the memory system 110 may increment the cursor 215-a to point to a next physical block (e.g., a next physical address) that subsequent data is to be written. As described herein, the memory system 110 may maintain a respective cursor 215 for each zone 205, such that a cursor 215-b may be maintained for the zone 205-c and a cursor 215-n may be maintained for the zone 205-n.

In response to performing the zonification procedure (e.g., zone write), the memory system 110 may update a change log to include the L2P mappings generated by the transfer of the data 210 to the zone 205-b. Accordingly, the memory system 110 may insert the change log into a change log manager (CLM) (e.g., change log engine), where the CLM may update an L2P table with the L2P mappings associated with the data 210. In this way, the memory system 110 may maintain the L2P mappings of the data 210 during zonification procedures.

In response to, or in conjunction with, updating the change log, the memory system 110 may perform a verification procedure, such as a RAIN procedure or read scan procedure, to identify whether program failures occurred during the transference of the data 210 to the zone 205-b and ensure that program fail without program status fail (PSF) can be recovered (e.g., determine that the data 210 can be recovered in case of program failures). In one example, the memory system 110 may utilize a RAIN procedure, where, during the zonification procedure, the memory system 110 may store one or more parity bits generated from the data 210 in one or more retention buffers (e.g., 384 kilobytes (KB)), where such buffers may be stored in the local memory 120. In this way, if the memory system 110 identifies program failures after writing the data 210 to the zone 205-b, the memory system 110 may recover the data 210 from the parity bits stored in the one or more retention buffers and rewrite the data 210 to the zone 205-b. In such examples, however, as the size (e.g., quantity) of data 210 increases, the size of the retention buffers stored in the local memory 120 may increase, thereby reducing the capacity of the local memory 120.

In another example, the memory system 110 may utilize a read scan procedure (e.g., such as a defrag procedure). For example, during the zonification procedure, the memory system 110 may lock the virtual blocks 180 of the zone 205-a, such that if program failures are identified in the zone 205-b, the memory system 110 may recover the data 210 from the virtual blocks 180 in the zone 205-a and rewrite the data 210 to the zone 205-b. In such examples, the memory system 110 may release the virtual blocks 180 of the zone 205 (e.g., source virtual blocks) in response to the completion of the read scan procedure. In some cases, the memory system 110 may determine that an integer multiple of eight word lines worth of data 210 to be written without program failures for one or more virtual blocks 180 of the zone 205-a to be released. In some examples, however, in response to the completion of the read scan procedure (e.g., defrag operation), the memory system 110 may be unable to release the virtual blocks 180 of the zone 205-a, leading to a reduction of resources in the memory system 110 (e.g., leading to no free virtual blocks 180 in the zone 205-a).

As described herein, the memory system 110 may maintain the mapping table 185, such that if program failures are identified, the memory system 110 may recover the data 210 from the zone 205-a using the mapping table 185. For example, because the data is written sequentially to the zone 205-b during the zonification procedure, the memory system 110 may maintain a compressed version of the change log (e.g., a L2P change log) in the mapping table 185 (e.g., temporarily store a compressed version of the change log in the local memory 120). Accordingly, if the memory system 110 identifies a program fail, the memory system 110 may perform an error handling procedure to recover the data 210 using the entries of the mapping table 185. For example, the memory system 110 may identify a PPA of the data 210 at the zone 205-a using the entries of the mapping table 185 (e.g., using the compressed L2P entries of the mapping table 185). Based on identifying the PPA of the data 210 in the zone 205-a, the memory system 110 may perform a synchronization read operation to recover the data 210 from the zone 205-a and rewrite the data 210 to the zone 205-b.

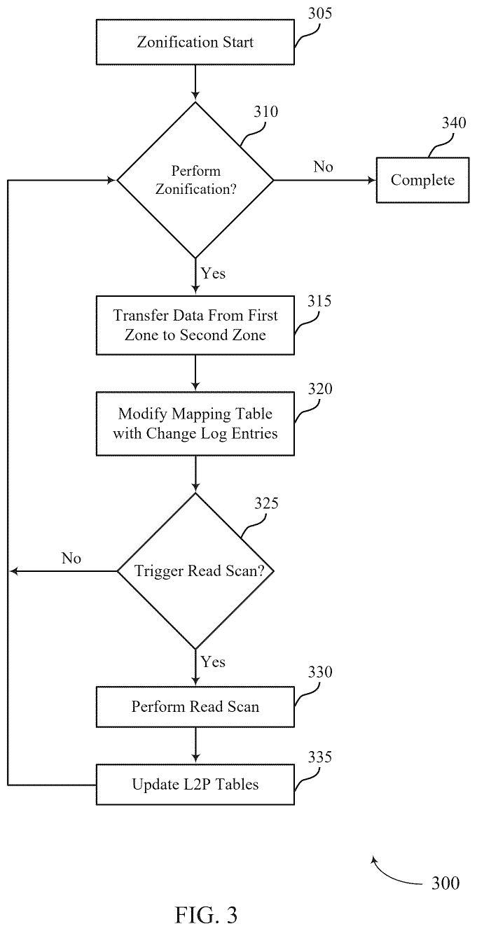

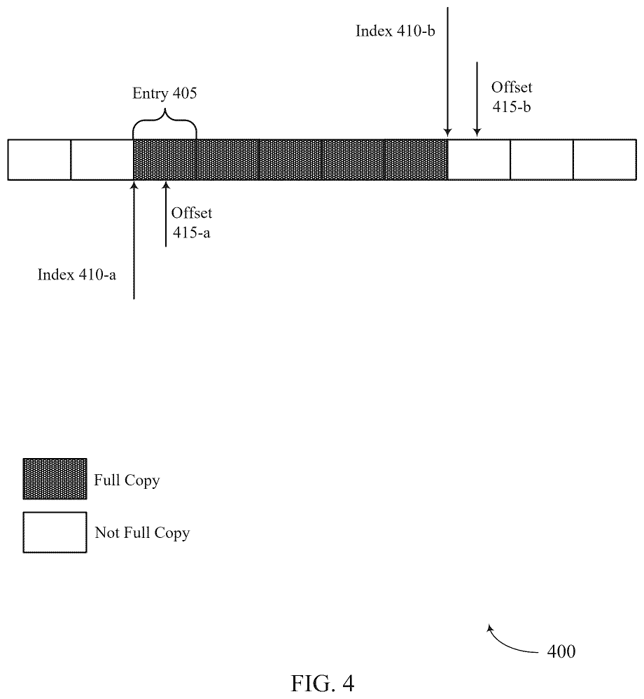

In this way, the memory system 110 may avoid locking the one or more virtual blocks 180 associated with the data in the source zone and reduce the size, or eliminate the use, of the one or more retention buffers. That is, because the memory system 110 may identify the physical pages used to store the data 210 in the zone 205-a, the memory system 110 may avoid locking the virtual blocks 180 of the zone 205-a. Additionally, because the mapping table 185 is a compressed version of the change log, the mapping table 185 may not consume a relatively large quantity of resources, as compared to the retention buffers used during the RAIN procedure, thereby saving resources at the memory system 110. Further, by using such techniques, the memory system 110 may realize increased efficiency during the zonification procedure (e.g., organizing zone data) and effectively protect the data 210 from program failures using the mapping table 185. Techniques to maintain the mapping table 185 during a verification procedure may be further described herein with reference to FIG. 3. An example of the mapping table 185 may be described herein with reference to FIG. 4.

FIG. 3 shows an example of a process flow 300 that supports managing mappings during zonification in accordance with examples as disclosed herein. Aspects of the process flow 300 may implement, or be implemented by, aspects of the system 100, and the zoned architecture 200 as described herein with reference to FIGS. 1 and 2. For example, the process flow 300 may be implemented by a memory system controller 115 of a memory system 110. The techniques described in the context of the process flow 300 may enable the memory system 110 to implement a mapping table 185 (e.g., a special cursor) for zonification procedures, which may reduce the constraints associated with one or more retention buffers and ensure program failure processing and data recovery.

Aspects of the process flow 300 may be implemented by one or more controllers, among other components. Additionally, or alternatively, aspects of the process flow 300 may be implemented as instructions stored in one or more memories (e.g., firmware stored in one or more memories coupled with the memory system 110). For example, the instructions, when executed by one or more controllers (e.g., the memory system controller 115 or local controllers 135), may cause the one or more controllers (or a device or a system) to perform the operations of the process flow 300.

At 305, a zonification procedure may start. At 310, performance of the zonification may be determined. For example, the memory system 110 may determine whether to transfer data (e.g., data 210) from a first zone (e.g., zone 205-a) to a second zone (e.g., zone 205-b) in response to a quantity of the data stored in the first zone satisfying a threshold. That is, the memory system 110 may identify that a size of the data (e.g., in KBs, megabytes (MBs), or the like) has reached a threshold. Accordingly, the memory system 110 may determine to perform the zonification procedure (e.g., zone write or zone copy) and procced to the operations at 315. Alternatively, if the memory system 110 determines that the quantity of data at the first zone does not satisfy the threshold (e.g., is less than), the memory system may refrain from performing the zonification procedure and proceed to the operations at 340 (e.g., completion).

At 315, the data may be transferred (e.g., written) from the first zone to the second zone. For example, in response to determining, at 310, to perform the zonification procedure, the memory system 110 may transfer the data from the first zone to the second zone. The memory system 110 may transfer the data according to the techniques described herein with reference to FIG. 2. For example, the memory system 110 may sequentially write the data from the first zone to the second zone.

In response to transferring the data, the memory system 110 may update one or more L2P mappings associated with the data and insert such L2P mappings into respective entries of a change log. In some examples, the memory system 110 may update the one or more entries of the change log in response to all of the data being written to the second zone. Alternatively, the memory system 110 may transfer a first portion of the data to a first physical address of the second zone, update an entry in the change log with a first L2P mapping, transfer a second portion of the data to a second physical address of the second zone, and update a second entry of the change log with a second L2P mapping. In this way, one or more entries of the change log may include one or more L2P address mappings that associate LBAs of the data with physical addresses of the data at the second zone.

At 320, the mapping table 185 may be modified with a compressed version of the one or more entries of the change log. That is, the memory system may store (e.g., modify, insert, among other examples) the compressed version of the one or more entries of the change log in the mapping table 185 in response to transferring the data from the first zone to the second zone. Because the zone write is sequential, the change log generated by transferring the data from the first zone to the second zone may be continuous, thereby enabling the memory system 110 to compress the entries of the change log. The mapping table 185 may include one or more entries, each associated with a compressed version of a respective entry of the change log.

As an illustrative example, in response to transferring the data from the first zone to the second zone, the memory system 110 may insert, into a first entry of the mapping table, a starting LBA associated with the data (e.g., zone WritePointer), a quantity of LBAs from the starting LBAs associated with the data (e.g., zone WriteCount), a starting physical address of the second zone associated with the data (e.g., zone WritePointer), a quantity of physical addresses from the starting physical address of the second zone (e.g., zone WriteCount), or a combination thereof. An example of an entry of the mapping table may be further described herein with reference to FIG. 4.

At 325, performance of a read scan procedure may be determined. For example, the memory system 110 may determine whether to whether to initiate the read scan procedure based on a size of the data transferred from the first zone to the second zone. If the size of the data transferred satisfies a second threshold, the memory system 110 may determine to perform the read scan procedure and proceed to the operations at 330. Alternatively, if the size of the data transferred fails to satisfy the second threshold, the memory system 110 may determine to refrain from performing the read scan procedure and procced to determine whether to perform another zonification procedure at 310.

At 330, the read scan procedure may be performed. For example, in response to determining to trigger the read scan at 325, the memory system 110 may perform the read scan procedure (e.g., a defrag procedure) to identify whether a program failure has occurred as part of transferring the data from the first zone to the second zone. In such examples, if the memory system 110 identifies a program failure, the memory system 110 may perform an error handling procedure to recover the data from the first zone, such that the memory system 110 may rewrite the data to the second zone.

For example, the memory system 110 may perform an error handling procedure using the entries of the mapping table 185. If a program fail is detected, the memory system 110 may use the mapping table 185 and RAIN procedures to recover the data. In these techniques, the source zone (e.g., where the data came from) has already been released. Thus, to recover the data, the other data protected by the RAIN parity is reconstructed from a different source. The memory system 110 may determine a PPA of the data in the first zone. To do so, the memory system 110 may obtain the start LBA associated with the data from the mapping table 185. In response to obtaining the start LBA from the mapping table 185, the memory system 110 determine (e.g., calculate), using the start LBA associated with the data and one or more offsets of the mapping table 185 (further described herein with reference to FIG. 4), whether the data was a hit (e.g., present) in a cache of the memory system 110. If the data was a hit in the cache, the memory system 110 may recover the data from the cache by performing a synchronization read operation and rewrite the data to the second zone. If the data was not a hit in the cache, the memory system 110 may perform one or more region calculations (e.g., synchronization load operations), RAIN recovery operations, or both to recover the data in the first zone. If such operations succeed, the memory system 110 may perform the synchronization read operation to obtain the data from the first zone and rewrite the data to the second zone. Alternatively, if such operations fail, the memory system 110 may trigger a recovery failure and set an uncorrectable error correction code (UECC).

At 335, an L2P table may be updated. For example, in response to performing the read scan at 330, the memory system 110 may update the L2P table to include the L2P mappings associated with the data using the compressed version of the one or more entries of the change log included in the mapping table 185. To do so, the memory system 110 may move the compressed version of the change log from the mapping table to a CLM, where the CLM may update the L2P table. In response to updating the L2P table, the memory system 110 may procced to determine whether to perform another zonification procedure at 310.

FIG. 4 shows an example of a mapping table 400 that supports managing mappings during zonification in accordance with examples as disclosed herein. Aspects of the mapping table 400 may be implemented by aspects of the system 100, the zoned architecture 200, and the process flow 300 as described herein with reference to FIGS. 1-3. For example, the mapping table 400 may be an example of the mapping table 185, where the memory system 110, the memory devices 130, or both may maintain the mapping table 400 in volatile memory (e.g., local memory 120 or volatile memory in local controllers 135). The mapping table 400 may be generated in response to the transference of data (e.g., data 210) from a first zone (e.g., source zone or zone 205-a) to a second zone (e.g., destination zone or zone 205-b).

The mapping table 400 may include one or more entries 405, where each entry 405 may be a compressed version of an entry of a change log, where the entry of the change log may be generated in response to transferring the data between the first zone and the second zone. That is, each entry 405 of the mapping table 400 may include information associated with respective sets of data that have been transferred between zones. For example, each entry 405 may include an indication of a zone number associated with the second zone (e.g., zoneNum), an indication of a zone temperature (e.g., zoneTemperature, representing an access frequency) associated with the second zone, an indication of a zone state of the second zone (e.g., zoneState, representing whether the zone is open or closed), an indication of a position of a zone write pointer (e.g., zoneWritePointer or cursor 215, representing a starting LBA or physical address of the data within the second zone) associated with the respective sets of data in the second zone, an indication of a zone write counter (e.g., zone WriteCount, representing a quantity of LBAs, physical addresses, or both) associated with the respective sets of data in the second zone, or a combination thereof. An example of a structure of the entry 405 in the mapping table 400 may be represented below:

```
typedef struct
{
  uint16_t zoneNum; // 0xFFFF not used, other zoneNum
  uint8_t zoneTemperature; // default: 0x0
  uint8_t zoneState; // open/ close
  uint16_t zoneWritePointer; // WP position
  uint16_t zoneWriteCount;
} DM_OpenZoneInfo_t;
```

The memory system 110 may manage the entries 405 of the mapping table 400 using one or more indexes 410, one or more offsets 415, or both. For example, the memory system 110 may manage the mapping table 400 using an index 410-a (e.g., a insertCLIndex), an offset 415-a (e.g., insertCLOffset), an index 410-b (e.g., curIndex), an offset 415-b (e.g., a current offset), a current zone offset (curZoneOffset), among other examples. Additionally, the memory system 110 may manage, along with the mapping table 400, a zone number of the current zone being written to during the zonification procedure (e.g., curZoneNumber) and a last merged PPA (e.g., lastMergePPA). An example of a structure of the mapping table 400 may be represented below:

```
typedef struct
{
  uint16_t curZoneNumber;
  uint32_t curZoneOffset;
  uint16_t curIndex;
  uint16_t curOffset;
  uint16_t insertCLIndex;
  uint16_t insertCLOffset;
  uint32_t lastMergePPA;
  DM_ZonificationRangeInfo_t
rangeCLInfo[DM_ZONIFICATION_MAX_RANGE_CL_CNT];
}DM_ZonificationMappingTable_t;
```

As described herein with reference to FIG. 3, during the zonification procedure, the memory system 110 may transfer the data from the first zone to the second zone, generate one or more L2P mappings associated with the data in response to transferring the data, and insert the one or more L2P mappings into the change log. In response, the memory system 110 may modify the mapping table 400 with compressed versions of the one or more entries of the change log (e.g., a compressed version of the L2P mappings associated with the data, such as a quantity of LBAs associated with the data). For example, the memory system 110 may generate an entry 405 for the data and insert the entry 405 into the mapping table 400 according to the index 410-b and the offset 415-b. If a program fail is identified during the transference of the data, the memory system 110 may identify, using the one or more indexes 410, the one or more offsets 415, and/or the information in each entry 405, to identify a PPA of the first zone (e.g., first zone), recover the data from the first zone, and write the data back to the second zone (e.g., second zone).

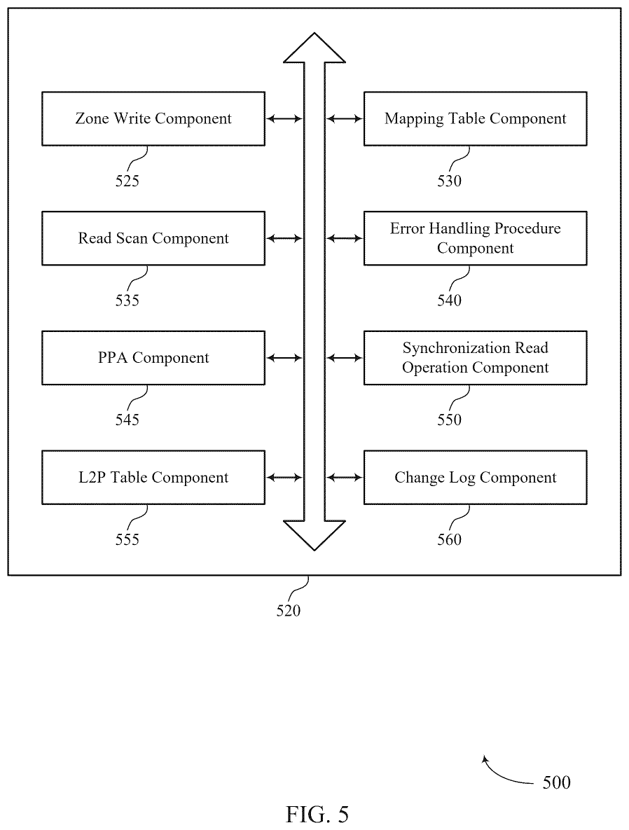

FIG. 5 shows a block diagram 500 of a memory system 520 that supports managing mappings during zonification in accordance with examples as disclosed herein. The memory system 520 may be an example of aspects of a memory system as described with reference to FIGS. 1 through 4. The memory system 520, or various components thereof, may be an example of means for performing various aspects of managing mappings during zonification as described herein. For example, the memory system 520 may include a zone write component 525, a mapping table component 530, a read scan component 535, an error handling procedure component 540, a PPA component 545, a synchronization read operation component 550, a L2P table component 555, a change log component 560, or any combination thereof. Each of these components, or components of subcomponents thereof (e.g., one or more processors, one or more memories), may communicate, directly or indirectly, with one another (e.g., via one or more buses).

The zone write component 525 may be configured as or otherwise support a means for transferring data from a first zone of the memory system to a second zone of the memory system, the memory system including a plurality of zones including the first zone and the second zone. The mapping table component 530 may be configured as or otherwise support a means for modifying a mapping table to include information associated with an entry of a change log generated by transferring the data from the first zone to the second zone, where the information in the mapping table includes a compressed version of one or more entries of the change log. The read scan component 535 may be configured as or otherwise support a means for performing, based at least in part on modifying the mapping table, a read scan procedure to identify whether a program failure has occurred as part of transferring the data from the first zone to the second zone. The error handling procedure component 540 may be configured as or otherwise support a means for performing, based at least in part on identifying that the program failure has occurred, an error handling procedure to recover the data using the mapping table.

In some examples, to support performing the error handling procedure, the PPA component 545 may be configured as or otherwise support a means for determining a PPA (e.g., physical page address) of the first zone that stores the data using the mapping table. In some examples, to support performing the error handling procedure, the synchronization read operation component 550 may be configured as or otherwise support a means for performing a synchronization read operation to recover the data based at least in part on determining the PPA of the first zone.

In some examples, the read scan component 535 may be configured as or otherwise support a means for determining whether to initiate the read scan procedure based at least in part on a size of the data transferred from the first zone to the second zone, where performing the read scan procedure is based at least in part on determining to initiate the read scan procedure.

In some examples, the L2P table component 555 may be configured as or otherwise support a means for updating, based at least in part on recovering the data, a L2P table using the compressed version of the one or more entries of the change log included in the mapping table.

In some examples, the zone write component 525 may be configured as or otherwise support a means for determining whether to transfer the data based at least in part on a quantity of the data stored in the first zone satisfying a threshold, where transferring the data is based at least in part on determining that the quantity satisfies the threshold.

In some examples, the zone write component 525 may be configured as or otherwise support a means for releasing a virtual block of the first zone associated with the data after transferring the data to the second zone and based at least in part on modifying the mapping table.

In some examples, the change log component 560 may be configured as or otherwise support a means for updating the one or more entries in the change log based at least in part on transferring the data from the first zone to the second zone, where modifying the mapping table is in response to updating the one or more entries in the change log.

In some examples, to support transferring the data, the zone write component 525 may be configured as or otherwise support a means for transferring a first portion of the data to a first address of the second zone. In some examples, to support transferring the data, the change log component 560 may be configured as or otherwise support a means for updating, based at least in part on transferring the first portion of the data, a first entry in the change log. In some examples, to support transferring the data, the zone write component 525 may be configured as or otherwise support a means for transferring a second portion of the data to a second address of the second zone. In some examples, to support transferring the data, the change log component 560 may be configured as or otherwise support a means for updating, based at least in part on transferring the second portion of the data, a second entry in the change log, where modifying the mapping table is based at least in part on updating the first entry and the second entry in the change log.

In some examples, the change log includes one or more entries indicating L2P address mappings associated with the data.

In some examples, the mapping table is stored in a buffer of the memory system.

In some examples, transferring the data from the first zone to the second zone uses one or more write cursors.

In some examples, each zone of the plurality of zones includes one or more pages of memory cells configured to be written sequentially and configured to be read in any order.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

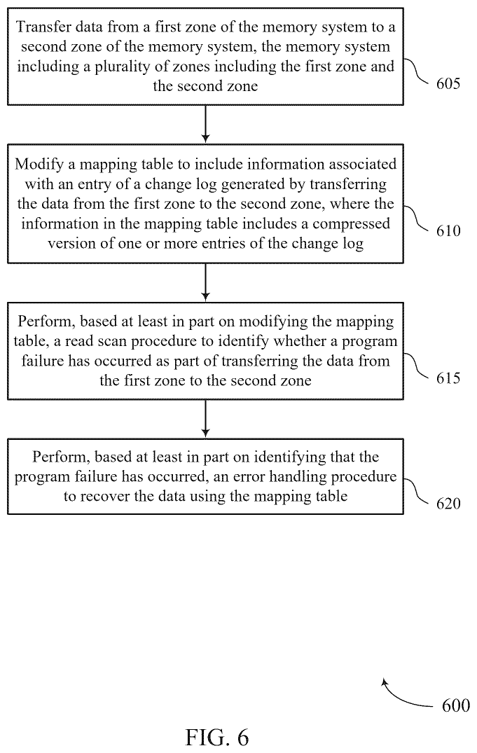

FIG. 6 shows a flowchart illustrating a process flow 600 that supports managing mappings during zonification in accordance with examples as disclosed herein. The operations of process flow 600 may be implemented by a memory system or its components as described herein. For example, the operations of process flow 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the process flow may include transferring data from a first zone of the memory system to a second zone of the memory system, the memory system including a plurality of zones including the first zone and the second zone. In some examples, aspects of the operations of 605 may be performed by a zone write component 525 as described with reference to FIG. 5.

At 610, the process flow may include modifying a mapping table to include information associated with an entry of a change log generated by transferring the data from the first zone to the second zone, where the information in the mapping table includes a compressed version of one or more entries of the change log. In some examples, aspects of the operations of 610 may be performed by a mapping table component 530 as described with reference to FIG. 5.

At 615, the process flow may include performing, based at least in part on modifying the mapping table, a read scan procedure to identify whether a program failure has occurred as part of transferring the data from the first zone to the second zone. In some examples, aspects of the operations of 615 may be performed by a read scan component 535 as described with reference to FIG. 5.

At 620, the process flow may include performing, based at least in part on identifying that the program failure has occurred, an error handling procedure to recover the data using the mapping table. In some examples, aspects of the operations of 620 may be performed by an error handling procedure component 540 as described with reference to FIG. 5.

In some examples, an apparatus as described herein may perform a process flow or process flows, such as the process flow 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transferring data from a first zone of the memory system to a second zone of the memory system, the memory system including a plurality of zones including the first zone and the second zone; modifying a mapping table to include information associated with an entry of a change log generated by transferring the data from the first zone to the second zone, where the information in the mapping table includes a compressed version of one or more entries of the change log; performing, based at least in part on modifying the mapping table, a read scan procedure to identify whether a program failure has occurred as part of transferring the data from the first zone to the second zone; and performing, based at least in part on identifying that the program failure has occurred, an error handling procedure to recover the data using the mapping table.

Aspect 2: The method, apparatus, or non-transitory computer-readable medium of aspect 1, where performing the error handling procedure includes operations, features, circuitry, logic, means, or instructions, or any combination thereof for determining a PPA (e.g., physical page address) of the first zone that stores the data using the mapping table and performing a synchronization read operation to recover the data based at least in part on determining the PPA of the first zone.

Aspect 3: The method, apparatus, or non-transitory computer-readable medium of any of aspects 1 through 2, further including operations, features, circuitry, logic, means, or instructions, or any combination thereof for determining whether to initiate the read scan procedure based at least in part on a size of the data transferred from the first zone to the second zone, where performing the read scan procedure is based at least in part on determining to initiate the read scan procedure.

Aspect 4: The method, apparatus, or non-transitory computer-readable medium of any of aspects 1 through 3, further including operations, features, circuitry, logic, means, or instructions, or any combination thereof for updating, based at least in part on recovering the data, a L2P table using the compressed version of the one or more entries of the change log included in the mapping table.

Aspect 5: The method, apparatus, or non-transitory computer-readable medium of any of aspects 1 through 4, further including operations, features, circuitry, logic, means, or instructions, or any combination thereof for determining whether to transfer the data based at least in part on a quantity of the data stored in the first zone satisfying a threshold, where transferring the data is based at least in part on determining that the quantity satisfies the threshold.

Aspect 6: The method, apparatus, or non-transitory computer-readable medium of any of aspects 1 through 5, further including operations, features, circuitry, logic, means, or instructions, or any combination thereof for releasing a virtual block of the first zone associated with the data after transferring the data to the second zone and based at least in part on modifying the mapping table.

Aspect 7: The method, apparatus, or non-transitory computer-readable medium of any of aspects 1 through 6, further including operations, features, circuitry, logic, means, or instructions, or any combination thereof for updating the one or more entries in the change log based at least in part on transferring the data from the first zone to the second zone, where modifying the mapping table is in response to updating the one or more entries in the change log.

Aspect 8: The method, apparatus, or non-transitory computer-readable medium of any of aspects 1 through 7, where transferring the data includes operations, features, circuitry, logic, means, or instructions, or any combination thereof for transferring a first portion of the data to a first address of the second zone; updating, based at least in part on transferring the first portion of the data, a first entry in the change log; transferring a second portion of the data to a second address of the second zone; and updating, based at least in part on transferring the second portion of the data, a second entry in the change log, where modifying the mapping table is based at least in part on updating the first entry and the second entry in the change log.

Aspect 9: The method, apparatus, or non-transitory computer-readable medium of any of aspects 1 through 8, where the change log includes one or more entries indicating L2P address mappings associated with the data.

Aspect 10: The method, apparatus, or non-transitory computer-readable medium of any of aspects 1 through 9, where the mapping table is stored in a buffer of the memory system.

Aspect 11: The method, apparatus, or non-transitory computer-readable medium of any of aspects 1 through 10, where transferring the data from the first zone to the second zone uses one or more write cursors.

Aspect 12: The method, apparatus, or non-transitory computer-readable medium of any of aspects 1 through 11, where each zone of the plurality of zones includes one or more pages of memory cells configured to be written sequentially and configured to be read in any order.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
transfer data from a first zone of the memory system to a second zone of the memory system, the memory system comprising a plurality of zones including the first zone and the second zone;
modify a mapping table to include information associated with an entry of a change log generated by transferring the data from the first zone to the second zone, wherein the information in the mapping table comprises a compressed version of one or more entries of the change log;
perform, based at least in part on modifying the mapping table, a read scan procedure to identify whether a program failure has occurred as part of transferring the data from the first zone to the second zone; and
perform, based at least in part on identifying that the program failure has occurred, an error handling procedure to recover the data using the mapping table.

2. The memory system of claim 1, wherein, to perform the error handling procedure, the processing circuitry is configured to cause the memory system to:
determine a physical page address (PPA) of the first zone that stores the data using the mapping table; and
perform a synchronization read operation to recover the data based at least in part on determining the PPA of the first zone.

3. The memory system of claim 1, wherein the processing circuitry is further configured to cause the memory system to:
determine whether to initiate the read scan procedure based at least in part on a size of the data transferred from the first zone to the second zone, wherein performing the read scan procedure is based at least in part on determining to initiate the read scan procedure.

4. The memory system of claim 1, wherein the processing circuitry is further configured to cause the memory system to:
update, based at least in part on recovering the data, a logical-to-physical (L2P) table using the compressed version of the one or more entries of the change log included in the mapping table.

5. The memory system of claim 1, wherein the processing circuitry is further configured to cause the memory system to:
determine whether to transfer the data based at least in part on a quantity of the data stored in the first zone satisfying a threshold, wherein transferring the data is based at least in part on determining that the quantity satisfies the threshold.

6. The memory system of claim 1, wherein the processing circuitry is further configured to cause the memory system to:
release a virtual block of the first zone associated with the data after transferring the data to the second zone and based at least in part on modifying the mapping table.

7. The memory system of claim 1, wherein the processing circuitry is further configured to cause the memory system to:
update the one or more entries in the change log based at least in part on transferring the data from the first zone to the second zone, wherein modifying the mapping table is in response to updating the one or more entries in the change log.

8. The memory system of claim 1, wherein, to transfer the data, the processing circuitry is configured to cause the memory system to:
transfer a first portion of the data to a first address of the second zone;
update, based at least in part on transferring the first portion of the data, a first entry in the change log;
transfer a second portion of the data to a second address of the second zone; and
update, based at least in part on transferring the second portion of the data, a second entry in the change log, wherein modifying the mapping table is based at least in part on updating the first entry and the second entry in the change log.

9. The memory system of claim 1, wherein the change log comprises one or more entries indicating logical to physical (L2P) address mappings associated with the data.

10. The memory system of claim 1, wherein the mapping table is stored in a buffer of the memory system.

11. The memory system of claim 1, wherein transferring the data from the first zone to the second zone uses one or more write cursors.

12. The memory system of claim 1, wherein each zone of the plurality of zones comprises one or more pages of memory cells configured to be written sequentially and configured to be read in any order.

13. A non-transitory computer-readable medium storing code, the code comprising instructions executable by one or more processors of a memory system to cause the memory system to:
transfer data from a first zone of the memory system to a second zone of the memory system, the memory system comprising a plurality of zones including the first zone and the second zone;
modify a mapping table to include information associated with an entry of a change log generated by transferring the data from the first zone to the second zone, wherein the information in the mapping table comprises a compressed version of one or more entries of the change log;
perform, based at least in part on modifying the mapping table, a read scan procedure to identify whether a program failure has occurred as part of transferring the data from the first zone to the second zone; and
perform, based at least in part on identifying that the program failure has occurred, an error handling procedure to recover the data using the mapping table.

14. The non-transitory computer-readable medium of claim 13, wherein the instructions to perform the error handling procedure are executable by the one or more processors of the memory system to cause the memory system to:
determine a physical page address (PPA) of the first zone that stores the data using the mapping table; and
perform a synchronization read operation to recover the data based at least in part on determining the PPA of the first zone.

15. The non-transitory computer-readable medium of claim 13, wherein the instructions are further executable by the one or more processors of the memory system to cause the memory system to:
determine whether to initiate the read scan procedure based at least in part on a size of the data transferred from the first zone to the second zone, wherein performing the read scan procedure is based at least in part on determining to initiate the read scan procedure.

16. The non-transitory computer-readable medium of claim 13, wherein the instructions are further executable by the one or more processors of the memory system to cause the memory system to:
update, based at least in part on recovering the data, a logical-to-physical (L2P) table using the compressed version of the one or more entries of the change log included in the mapping table.

17. The non-transitory computer-readable medium of claim 13, wherein the instructions are further executable by the one or more processors of the memory system to cause the memory system to:
determine whether to transfer the data based at least in part on a quantity of the data stored in the first zone satisfying a threshold, wherein transferring the data is based at least in part on determining that the quantity satisfies the threshold.

18. A method at a memory system, comprising:
transferring data from a first zone of the memory system to a second zone of the memory system, the memory system comprising a plurality of zones including the first zone and the second zone;
modifying a mapping table to include information associated with an entry of a change log generated by transferring the data from the first zone to the second zone, wherein the information in the mapping table comprises a compressed version of one or more entries of the change log;
performing, based at least in part on modifying the mapping table, a read scan procedure to identify whether a program failure has occurred as part of transferring the data from the first zone to the second zone; and
performing, based at least in part on identifying that the program failure has occurred, an error handling procedure to recover the data using the mapping table.

19. The method of claim 18, wherein performing the error handling procedure comprises:
determining a physical page address (PPA) of the first zone that stores the data using the mapping table; and
performing a synchronization read operation to recover the data based at least in part on determining the PPA of the first zone.

20. The method of claim 18, further comprising:
determining whether to initiate the read scan procedure based at least in part on a size of the data transferred from the first zone to the second zone, wherein performing the read scan procedure is based at least in part on determining to initiate the read scan procedure.

21. The method of claim 18, further comprising:
updating, based at least in part on recovering the data, a logical-to-physical (L2P) table using the compressed version of the one or more entries of the change log included in the mapping table.

22. The method of claim 18, further comprising:
determining whether to transfer the data based at least in part on a quantity of the data stored in the first zone satisfying a threshold, wherein transferring the data is based at least in part on determining that the quantity satisfies the threshold.
